(19) United States
(12) Patent Application Publication
(10) Pub. No.: US 2025/0140964 A1
(43) Pub. Date: May 1, 2025

(54) Battery Module

(71) Applicant: LG Energy Solution, Ltd., Seoul (KR)

(72) Inventors: Min Yong Jung, Daejeon (KR); Bum Choi, Daejeon (KR); Jong Yoon Keum, Daejeon (KR); Soo Jun Ahn, Daejeon (KR); Jae Heon Chung, Daejeon (KR)

(73) Assignee: LG Energy Solution, Ltd., Seoul (KR)

(21) Appl. No.: 18/693,668

(22) PCT Filed: Mar. 15, 2023
(86) PCT No.: PCT/KR2023/003435

§ 371 Date: Mar. 20, 2024

(30) Foreign Application Priority Data
Mar. 17, 2022 (KR) 10-2022-0033660

(51) Int. Cl. H01M 10/653; A62C 3/16; A62C 35/10; H01M 10/613; H01M 10/643; H01M 10/6567; H01M 50/213; H01M 50/342; H01M 50/673

(52) U.S. Cl. CPC H01M 10/653; A62C 3/16; A62C 35/10; H01M 10/613; H01M 10/643; H01M 10/6567; H01M 50/213; H01M 50/3425; H01M 50/673

(57) ABSTRACT

A battery module includes a plurality of battery cells and a plurality of vents, each vent associated with a respective battery cell. A heat sink is positioned adjacent the vents parts and is configured to dissipate heat from the plurality of battery cells. The heat sink includes a heat dissipation case having a metal material and a resinous material and defining a flow path groove through which cooling water is configured to flow, and a heat dissipation film adjacent the vents and coupled to the heat dissipation case and surrounding the flow path groove.

### CROSS-REFERENCE TO RELATED APPLICATIONS

The present application is a national phase entry under 35 U.S.C. § 371 of International Application No. PCT/KR2023/003435 filed Mar. 15, 2023, which claims the benefit of Korean Patent Application No. 10-2022-0033660 filed on Mar. 17, 2022, with the Korean Intellectual Property Office, the entire contents of which are incorporated herein by reference.

### BACKGROUND OF THE INVENTION

### Technical Field

The present invention relates to a battery module, and specifically, to a battery module capable of extinguishing flames as cooling water in a heat sink flows into a battery cell upon ignition of the battery cell.

### Background Art

FIG. 1 illustrates a battery module according to the prior art. Specifically, FIG. 1 is a diagram for explaining chain ignition of a battery cell.

Referring to FIG. 1, a battery module (10) may comprise a plurality of battery cells (11) and a heat sink (12) attached to the battery cells (11).

Generally, in the case of a can-type battery cell (11), a vent part (11a) allows gas, heat, and the like to be discharged. When ignition occurs inside the battery cell (11), the vent part (11a) is opened by the internal pressure of the battery cell (11), and flames are ejected to the outside of the battery cell (11).

When the side of the vent part (11a) of the battery cell (11) is attached to the heat sink (12), the heat sink (12) blocks the vent part (11a) of the battery cell upon ignition inside the battery cell (11). In this case, upon ignition of the battery cell (11), the vent part (11a) does not open, and as a result, the internal pressure of the battery cell (11) continuously increases, and the flames tear the side of the battery cell (11) and are ejected to the outside.

When flames are ejected to the side of the battery cell (11) they may transfer to adjacent battery cells, thereby causing chain ignition.

### BRIEF SUMMARY OF THE INVENTION

### Technical Problem

A problem to be solved by the present disclosure is to provide a battery module, wherein when a battery cell is ignited and opens a vent part, cooling water in a heat sink flows down to the ignited battery cell while the heat sink is damaged. Such a configuration may extinguish flames before spreading to adjacent battery cells.

Additionally, a problem to be solved by the present disclosure is to provide a battery module, wherein when a vent part is opened, a heat dissipation film manufactured in the form of a thin film is torn.

In addition, a problem to be solved by the present disclosure is to provide a battery module capable of preventing chain ignition of battery cells.

### Technical Solution

In order to solve the above problems, according to one aspect of the present disclosure, a battery module comprising a plurality of battery cells having vent parts, and a heat sink disposed to face the vent parts and provided to dissipate heat from the plurality of battery cells is provided. The vent part is normally maintained in a closed state, but when an event such as a thermal runaway of the battery cell occurs, it is opened in the case that gas or a flame is generated inside the battery cell, whereby it is configured so that the gas or flame is discharged to the outside of the battery cell. The vent part may be provided by a method of forming a notch or the like in a specific portion of the battery cell case so that the relevant specific portion is ruptured when the internal pressure of the battery cell increases. The plurality of battery cells is arranged so that the respective vent parts are disposed side by side while facing the same direction. In this case, the vent part of each battery cell is arranged to face the heat sink.

The heat sink comprises a heat dissipation case having a metal material and a resinous material and having a flow path groove forming a cooling flow path through which cooling water flows, and a heat dissipation film disposed to face the vent parts and coupled to the heat dissipation case to surround the flow path groove.

Also, it may be provided so that upon inside ignition of the battery cell, the cooling water flowing through the cooling flow path flows into the battery cell while the heat dissipation film facing the vent part is damaged.

In addition, the heat dissipation case may comprise a metal layer and a resin layer provided on one side of the metal layer.

As one example, two or more layers of the resin layer may be laminated, and the respective layers may be formed of the same or different resins.

As another example, the resin layer may comprise a first resin layer provided on one side of the metal layer and a second resin layer provided on the other side of the metal layer. At this instance, the first resin layer and the second resin layer may be formed of the same or different resin materials.

As another example, the resin layer may comprise a first resin layer provided on one side of the metal layer and a second resin layer provided on the first resin layer. At this instance, the first resin layer and the second resin layer may be formed of the same or different resin materials.

Also, the metal layer may comprise one or more selected from the group consisting of aluminum, stainless steel, and steel plate.

In addition, the heat sink may further comprise an inflow port provided on one side of the flow path groove and an outflow port on the other side of the flow path groove.

Furthermore, the inflow port and the outflow port may each have a port body with a hollow inside and a port protrusion part protruding outward from the port body. In addition, the port body may be inserted into the flow path groove, and the port protrusion part may be supported on the heat dissipation case.

Also, in the inflow port and the outflow port, the port protrusion parts may each be coupled to an outer circumferential surface of the heat dissipation case.

In addition, the heat sink may comprise a washer member disposed between the port protrusion part and the heat dissipation case.

Furthermore, the heat sink may comprise a coupling member screw-coupled to the port body inside the flow path groove and a sealing member disposed between the coupling member and the heat dissipation case inside the flow path groove.

Also, the sealing member may be arranged to contact the heat dissipation case.

In addition, the heat dissipation case may be vacuum-molded so that the flow path groove is provided.

Furthermore, the heat dissipation film may have a thickness of 10 μm to 300 μm.

Also, the heat dissipation case may have a thickness of 0.3 mm to 20 mm.

In addition, the heat dissipation film may be a film that a polymer resin film is compressed on a metal film, where the metal film may be an aluminum film, and the polymer resin film may comprise one or more selected from the group consisting of polypropylene (PP), nylon, and polyethylene terephthalate (PET)-based resins.

As one example, in the heat dissipation film, a polypropylene (PP) film may be compressed on one side of the metal film and a nylon film may be compressed on the other side of the metal film.

As another example, in the heat dissipation film, a polypropylene (PP) film may be compressed on one side of the metal film, and a nylon film and a polyethylene terephthalate film (PET) may be compressed on the other side of the metal film in a double layer form.

### Advantageous Effects

As described above, the battery module related to one example of the present invention may have the following effects.

As the heat dissipation film of the heat sink disposed to face the vent part of the battery cell is manufactured in the form of a thin film, the heat dissipation film is torn by the force caused by internal pressure of the battery cell pushing the vent part upon internal ignition of the battery cell. As the vent part is smoothly opened while the heat dissipation film is damaged, it is possible to prevent the battery cell from exploding to the side, thereby preventing chain ignition.

Also, upon internal ignition of the battery cell, the heat dissipation film facing the vent part of the battery cell is torn by the pressure that opens the vent part of the battery cell, and simultaneously the cooling water flowing inside the heat sink flows down to the battery cell, whereby it is possible to extinguish flames within a battery cell.

In addition, as the flame of the ignited battery cell is extinguished quickly to suppress the temperature rise of the ignited battery cell and the battery cells adjacent thereto, it is possible to improve the safety of the battery module.

Furthermore, as the heat sink is made of a composite material including a metal material, it is possible to improve heat dissipation properties.

In addition, compared to conventional heat sinks made of only resins, the heat dissipation case is made of a composite material including a resin material and a metal material, whereby it is possible to improve structural rigidity, and it is possible to reduce the footprint of the heat sink.

### DESCRIPTION OF DRAWINGS

FIG. 1 is a perspective view of chain ignition occurring upon ignition of a battery cell according to the prior art.

FIG. 2 is a perspective view of a partial region of a battery module according to one example of the present invention.

FIG. 3 is a side cross-sectional view of a battery module according to one example of the present invention.

FIG. 4 is a cross-sectional view of a composite material included in a heat dissipation case.

FIG. 5 schematically illustrates various examples of a heat dissipation case.

FIG. 6 is a cross-sectional view of a heat dissipation film.

FIG. 7 is a side cross-sectional view of a coupling structure of an inflow port and a heat sink.

FIG. 8 is side views for various sealing members according to aspects of the disclosure.

FIG. 9 is a side cross-sectional view of a coupling structure of an inflow port and a heat sink.

FIG. 10 is a side view of cooling water discharged from a heat sink upon internal ignition of a battery cell.

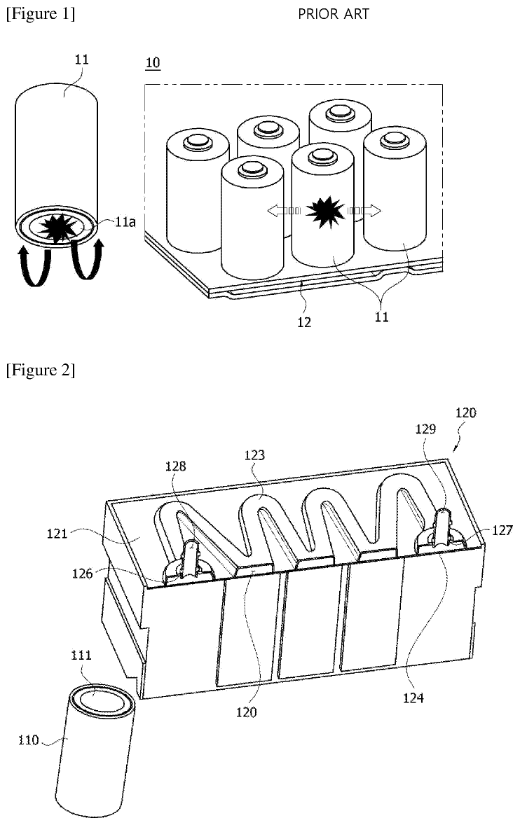

### DETAILED DESCRIPTION OF THE PREFERRED EMBODIMENTS

Hereinafter, a battery module according to one example of the present invention will be described in detail with reference to the drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

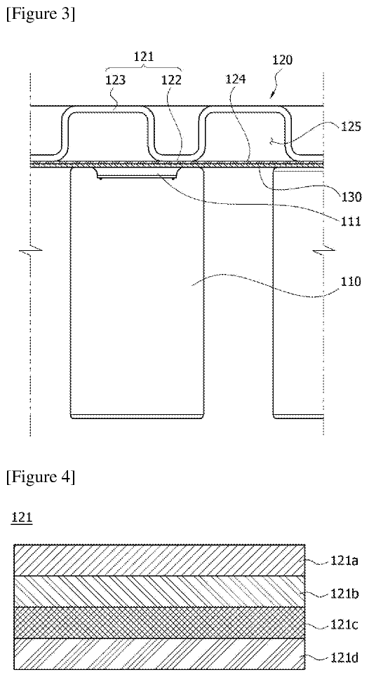

FIG. 2 is a perspective diagram of a state where a partial region of a battery module according to one example of the present invention has been cut, and FIG. 3 is a cross-sectional diagram schematically showing a battery module according to one example of the present invention.

Referring to FIG. 2, a battery module (100) according to one example of the present invention comprises a plurality of battery cells (110) and a heat sink (120).

Upon internal ignition of the battery cell (110), the heat dissipation film (124) of the heat sink (120) is torn by the pressure that opens the vent part (111) of the battery cell (110). Simultaneously, cooling water flows down to the battery cell (110) through the torn portion of the heat dissipation film. As a result, continuous ignition of the battery cell (110) may be prevented.

As one example, the battery cell (110) is a cylindrical battery cell (110), where an electrode assembly (positive electrode, negative electrode, separator, etc.) may be embedded therein. A vent part (111) is provided in the battery cell (110). Because battery cells (110) are known in the art, a detailed description thereof will be omitted for brevity.

Referring to FIGS. 2 and 3, the heat sink (120) is coupled to the plurality of battery cells (110) so that a partial region of the vent part (111) in the battery cell (110) is positioned to be overlapped on the cooling flow path (125). In addition, the heat sink (120) may be coupled to the battery cell (110) by an adhesive (130).

The battery cell (110) is preferably coupled to the heat sink (120) such that a surface area on a film coupling surface (122) is minimized. Such a configuration allows the vent part (111) of the battery cell (110) to be opened more easily upon internal ignition of the battery cell (110).

The heat sink (120) may comprise a heat dissipation case (121), a heat dissipation film (124), an inflow port (128) and an outflow port (129). The heat sink (120) is coupled to the battery cell (110) to dissipate heat away from the battery cell (110).

The heat dissipation case (121) is combined with the heat dissipation film (124) to form a cooling flow path (125) through which cooling water flows. As one example, the heat dissipation case (121) is vacuum-molded so that the flow path groove (123) forming a cooling flow path (125).

The heat dissipation case (121) may comprise a film coupling surface (122), a flow path groove (123), an inflow opening (126) and an outflow opening (127).

The flow path groove (123) is provided stepwise with respect to the film coupling surface (122). The flow path groove (123) may be provided so that cooling water is flowable over the entire area of the heat dissipation case (121) in a zigzag shape. The flow path groove (123) guides the flow of cooling water from the inflow port (128) to the outflow port (129) along the longitudinal direction (L) of the heat dissipation case.

An inflow opening (126) and an outflow opening (127) are provided in the flow path groove (123). The inlet opening (126) may be provided at the front end (the upstream end) of the flow path groove (123), and the outflow opening (127) may be provided at the rear end (the downstream end) of the flow path groove (123) on the opposite side of the inflow opening (126).

In addition, the heat dissipation case (121) is made of a composite material including metal.

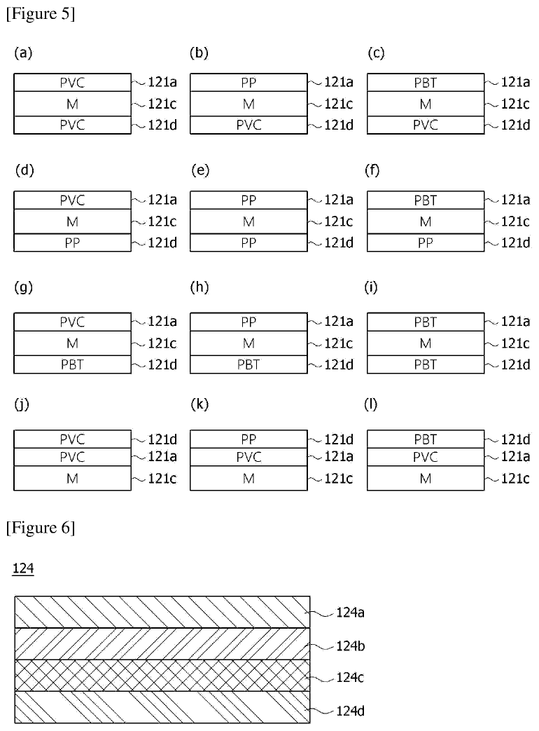

FIG. 4 schematically illustrates a cross section of a composite material constituting a heat dissipation case, and FIG. 5 schematically illustrates various examples of a heat dissipation case. Reference symbol M in FIG. 5 shows a metal layer.

Referring to FIG. 4, the composite material comprises a metal material, where the metal layer may be surface-treated with a resin material. As one example, the composite material comprises a metal layer (121c), a first resin layer (121a), and a second resin layer (121d).

The metal layer (121c) may comprise one or more selected from the group consisting of aluminum, stainless steel, or steel plate. In the metal layer (121c), at least one side of the metal layer (121c) is insulated by the resin layer (121a, 121d).

The first resin layer (121a) may be provided on one side of the metal layer (121c). As one example, the first resin layer (121a) may comprise one or more selected from the group consisting of a polyvinyl chloride (PVC)-based resin, a polypropylene (PP)-based resin, and a polybutyl terephthalate (PBT)-based resin. In addition, the first resin layer (121a) may be bonded to the metal layer (121c) by an adhesive (121b).

In addition, the resin layer (121a, 121d) may be formed in a multilayer structure in which two or more layers are laminated. As one example, the resin layer (121a, 121d) may be provided on one side of the metal layer as a double layer structure.

The resin layer (121a, 121d) may be provided on both sides of the metal layer (121c), respectively. Alternatively, the resin layer (121a, 121d) may be provided on any one side of the metal layer (121c) in a laminated form, that is, in a double layer form.

Throughout the present disclosure, the resin layer (121a, 121d) may be separately referred to as “a first resin layer (121a) and a second resin layer (121d)”. The first resin layer (121a) and/or the second resin layer (121d) may each be bonded to the metal layer (121c) by an adhesive (121b).

The first resin layer (121a) and the second resin layer (121d) may be formed of the same or different resin materials. As one example, the first resin layer (121a) and the second resin layer (121d) may each comprise one or more selected from the group consisting of a PVC-based resin, a PP-based resin, and a PBT-based resin.

A PVC (polyvinyl chloride)-based resin is inexpensive. A PP (poly propylene)-based resin has excellent chemical resistance and balance. A PBT (polybutylene terephthalate)-based resin has excellent heat resistance. Depending on the intended use of the composite material, the types of resins are variable and may be combined.

Referring to FIG. 5, the first resin layer (121a) and the second resin layer (121d) may be provided on one side or both sides of the metal layer (121c) in various combinations.

The first resin layer (121a) may be a double layer in which one side is provided with any one of the PVC-based resin, PP-based resin, and PBT-based resin, and the other side is provided with another resin. For example, when the PVC-based resin constitutes one side of the first resin layer (121a) and the PP-based resin constitutes the other side of the first resin layer (121a), the molecular structure of the PVC-based resin and the molecular structure of the PP-based resin are different from each other, whereby the first resin layer (121a) can prevent pinholes from forming.

The second resin layer (121d) may be provided on the other side of the metal layer (121c). The second resin layer (121d) comprises one or more selected from the group consisting of a PVC-based resin, a PP-based resin, and a PBT-based resin.

The second resin layer (121d) may have a double layer in which any one of the PVC-based resin, PP-based resin, and PBT-based resin constitutes one side and another resin constitutes the other side.

In such a structure, the heat dissipation case (121) may have structural rigidity and heat dissipation due to the metal layer (121c), and may secure insulation properties due to the first resin layer (121a) and the second resin layer (121d).

FIG. 6 schematically illustrates a cross section of a heat dissipation film.

The heat dissipation film (124) is a thin film. The heat dissipation film (124) has a thickness ranging from 10 μm to 990 μm. The heat dissipation film (124) has heat dissipation and insulation properties.

The heat dissipation film (124) is configured to be torn by a force caused by ignition of the battery cell (110). When such an ignition occurs, the vent part (111) of the battery cell (110) is opened, and simultaneously the vent part (111) pushes up the heat dissipation film (124). Depending on the specification and size of the battery cell (110), the structure of the vent part (111), and the like, the pressure at which the vent part (111) is opened may be determined upon ignition. Similarly, when the vent part (111) is opened, the pressure applied to the heat dissipation film (124) may be measured or calculated. The heat dissipation film (124) may become damaged according to the pressure applied while the vent part (111) is opened, and to this end, the thickness, material, or physical properties, and the like of the heat dissipation film (124) may be adjusted to minimize potential damage to the head dissipation film (124).

As one example, the heat dissipation film (124) may be a polymer resin film compressed on a metal film. The metal film may comprise an aluminum film. Referring to FIG. 6, the heat dissipation film (124) is a film that a polypropylene (PP) film (124a), an aluminum film (124b), a nylon film (124c), and a polyethylene terephthalate (PET) film (124d) are laminated and compressed.

The heat dissipation film (124) may be coupled to the film coupling surface (122) of the heat dissipation case (121) in a thermal compression method. The heat dissipation film (124) may be coupled to the film coupling surface (122) to cover the flow path groove (123), thereby forming a cooling flow path (125).

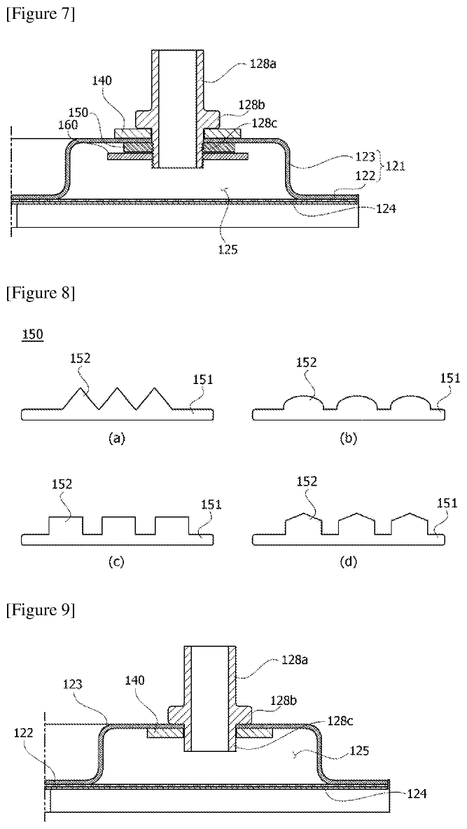

FIG. 7 is a schematic cross-sectional diagram for explaining one coupling structure of an inflow port and a heat sink, FIG. 8 is schematic diagrams showing a sealing member, and FIG. 9 is a schematic cross-sectional diagram for explaining a coupling structure of an inflow port and a heat sink.

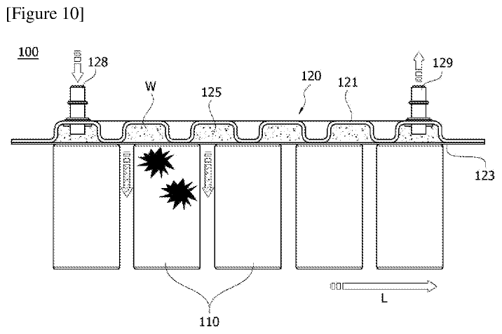

FIG. 10 is a diagram for explaining an operation in which cooling water is discharged from a heat sink upon inside ignition of a battery cell.

The inflow port (128) is a passage through which the cooling water (W) flows into the cooling flow path (125). The inflow port (128) is coupled to the heat dissipation case (121) so as to communicate with the flow path groove (123) by penetrating the inflow opening (126).

The outflow port (129) is a passage through which the cooling water (W) is discharged from the cooling flow path (125). The outflow port (129) is coupled to the heat dissipation case (121) so as to communicate with the flow path groove (123) by penetrating the outflow opening (127). The outflow port (129) is coupled to the heat dissipation case (121) on the side opposite to the inflow port (128) along the longitudinal direction (L) of the heat dissipation case (121).

The inflow port (128) and the outflow port (129) have the same structure. Accordingly, in this example, it will be described based on the inflow port (128).

The inflow port (128) comprises a port body (128a) and a port protrusion part (128b).

The port body (128a) has a form with a hollow cavity inside. The port protrusion part (128b) is provided at the lower end (128c) of the port body. The port protrusion part (128b) is provided to protrude outward from the port body (128a). The port protrusion part (128b) may be integrally provided with the port body (128a).

The inflow port (128) may be coupled to the heat dissipation case so that the lower end (128c) of the port body is inserted into the flow path groove (123) by passing through the inflow opening (126), and the port protrusion part (128b) is caught on the outer surface of the heat dissipation case (121).

As one example, referring to FIG. 7, the inflow port (128) may be coupled to the heat dissipation case (121) through a washer member (140), a sealing member (150), and a coupling member (160).

Also, the washer member (140) may be installed between the heat dissipation case (121) and the port protrusion part (128b) so that the port protrusion part (128b) is penetrated by the lower end (128c) of the port body.

In addition, the sealing member (150) may be coupled to the port body (128a) on the inside of the flow path groove (123) to penetrate the lower end (128c) of the port body between the inner surface of the heat dissipation case (121) and the coupling member (160). The sealing member (150) is configured to seal a gap between the heat dissipation case (121) and the pot body (128a). The sealing member (150) may be made of a material having a predetermined elasticity.

Referring to FIG. 8, the sealing member (150) may have a plurality of sealing protrusions (152) protruding from the reference surface (151). The sealing protrusion (152) may have any one of a triangular section, a quadrangular section, a semicircular section, a loud section, or a sharp polygonal section.

Referring to FIG. 7, the coupling member (160) penetrates the lower end (128c) of the port body on the inside of the flow path groove (123), but may be screw-coupled along a screw thread provided at the lower end (128c) of the port body.

When the washer member (140) is fitted to the lower end (128c) of the port body so as to contact the port protrusion part (128b), the inflow port (128) may be coupled so that the lower end (128c) of the port body penetrates the inflow opening (126), and thus the washer member (140) surrounds the inflow opening (126) on the outer circumferential surface of the heat dissipation case (121).

The sealing protrusion (152) of the sealing member (150) contacts the inner surface of the heat dissipation case (121), and the coupling member (160) is screw-coupled to the lower end (128c) of the port body while contacting with the reference surface (151) of the sealing member (150), whereby the inflow port (128) may be coupled to the heat dissipation case (121) on the inside of the flow path groove (123).

As another example, referring to FIG. 9, the port protrusion part (128b) may be coupled to the outer surface of the heat dissipation case (121) by thermal fusion. In addition, the lower end (128c) of the port body may be coupled to the inner surface of the heat dissipation case (121) by the washer member (140) on the inside of the flow path groove (123). The washer member (140) may be coupled to the inner surface of the heat dissipation case (121) by an adhesive by penetrating the lower end (128c) of the port body.

Referring to FIG. 10, the heat dissipation film (124) is torn by the force that upon internal ignition of the battery cell (110), the vent part (111) of the battery cell (110) is opened, and simultaneously the vent part (111) pushes up the heat dissipation film (124). At this time, the cooling water (W) flowing through the cooling flow path (125) down to the ignited battery cell (110).

Accordingly, the present disclosure can improve the safety of the battery module (100) by extinguishing the flame of the ignited battery cell (110) quickly, thereby suppressing the temperature rise of the ignited battery cell (110) and the adjacent battery cells (110).

The preferred examples of the present invention as described above have been disclosed for illustrative purposes, and those skilled in the art having ordinary knowledge of the present invention will be able to make various modifications, changes, and additions within the spirit and scope of the present invention, and such modifications, changes, and additions should be regarded as falling within the scope of the following claims.

### INDUSTRIAL APPLICABILITY

According to the battery module in accordance with one example of the present invention, upon inside ignition of the battery cell, the heat dissipation film opposing the vent part of the battery cell is torn by the pressure that the vent part of the battery cell is opened, and simultaneously the cooling water flowing inside the heat sink flows down to the battery cell, whereby it is possible to early extinguish the flame of the ignited battery cell.

1. A battery module comprising:
a plurality of battery cells and a plurality of vents, each vent associated with a respective battery cell; and
a heat sink adjacent the vents and configured to dissipate heat away from the plurality of battery cells, wherein
the heat sink includes a heat dissipation case having a metal material and a resinous material and defining a flow path groove through which cooling water is configured to flow, and a heat dissipation film adjacent the vents and coupled to the heat dissipation case and surrounding the flow path groove.

2. The battery module according to claim 1, wherein
upon ignition of the battery cell, the cooling water is configured to flow through the flow path groove into the battery cell when the heat dissipation film is damaged.

3. The battery module according to claim 1, wherein
the heat dissipation case includes a metal layer; and
a resin layer is provided on one side of the metal layer.

4. The battery module according to claim 3, wherein
two or more layers of the resin layer are laminated, and
the tow or more layers are formed of the same or different resins.

5. The battery module according to claim 3, wherein the resin layer includes
a first resin layer provided on one side of the metal layer and a second resin layer provided on an opposing side of the metal layer, wherein
the first resin layer and the second resin layer are formed of the same or different resin materials.

6. The battery module according to claim 3, wherein the resin layer includes
a first resin layer provided on one side of the metal layer and a second resin layer provided on the first resin layer, wherein
the first resin layer and the second resin layer are formed of the same or different resin materials.

7. The battery module according to claim 3, wherein
the metal layer comprises one or more selected from a group consisting of aluminum, stainless steel, and steel plate.

8. The battery module according to claim 1, wherein
the heat sink further comprises an inflow port on one side of the flow path groove and an outflow port on an opposing side of the flow path groove.

9. The battery module according to claim 8, wherein
the inflow port and the outflow port each include a port body defining an internal cavity and a port protrusion part protruding outward from the port body, wherein
the port body is configured to be inserted into the flow path groove, and the port protrusion part is configured to be supported on the heat dissipation case.

10. The battery module according to claim 9, wherein
the port protrusion parts are each coupled to an outer circumferential surface of the heat dissipation case.

11. The battery module according to claim 10, further comprising
a washer member disposed between at least one of the port protrusion parts and the heat dissipation case.

12. The battery module according to claim 11, further comprising
a coupling member coupled to the port body inside the flow path groove, and a sealing member disposed between the coupling member and the heat dissipation case inside the flow path groove.

13. The battery module according to claim 12, wherein
the sealing member includes a plurality of sealing protrusions configured to contact the heat dissipation case.

14. The battery module according to claim 1, wherein
the heat dissipation case is vacuum-molded.

15. The battery module according to claim 1, wherein
the heat dissipation film has a thickness of 10 μm to 300 μm, and
the heat dissipation case has a thickness of 0.3 mm to 20 mm.
